(19) United States
(12) Patent Application Publication
(10) Pub. No.: US 2010/0115765 A1
(43) Pub. Date: May 13, 2010

(54) Layout verification apparatus, layout apparatus, layout verification method, layout verification program, and wiring forming method

(75) Inventor: Takeshi Hamamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/585,441

(22) Filed: Sep. 15, 2009

(30) Foreign Application Priority Data
Nov. 12, 2008 (JP) 290083/2008

(51) Int. Cl. H01R 43/00; G06F 17/50

(52) U.S. Cl. 29/825; 716/21; 716/19; 716/5

(57) ABSTRACT

The layout verification apparatus includes: a verification unit for obtaining mask data indicating a mask pattern to be drawn on a mask based on layout and wiring data indicating positions of a group of primitive cells and positions of connection wires connected to the group of primitive cells, and for verifying a position of the mask pattern based on the mask data, so as to detect an error part; and a correction hint creating unit for creating correction hint information based on the error part, and for sending the correction hint information to a layout and wiring unit for correcting the layout and wiring data. The correction hint creating unit obtains terminal information indicating positions of a group of terminals included in the group of primitive cells and creates the correction hint information based on the terminal information so that the positions of the group of terminals are not changed by the layout and wiring unit.

### BACKGROUND OF THE INVENTION

1. Field of the Invention

The present invention relates to a layout verification apparatus, a layout apparatus, a layout verification method, a layout verification program, and a wiring forming method.

2. Description of the Related Art

When a circuit such as a semiconductor integrated circuit is manufactured, a layout pattern thereof is designed first. After that, a photomask (hereinafter, referred simply to as a mask) is created based on the layout pattern. A pattern drawn on the mask is transferred onto a substrate, and thus an actual circuit is obtained.

When the layout pattern is designed, in the first place, positions of a group of primitive cells are determined, and positions of a group of wirings connecting the primitive cells are determined so that a desired circuit operation may be obtained. Thus, layout and wiring data is obtained. A pattern drawn on the mask is not always identical to a pattern formed actually on the substrate due to various factors including an optical proximity effect and the like. Therefore, it is verified whether or not a desired pattern is obtained by using the layout and wiring data. Further, based on a result of the verification, the layout and wiring data is corrected. After that, final verification is performed about whether or not signal communication timings become desired timings. If there is no problem, the layout and wiring data is output as the layout pattern.

A technology related to verification and correction of the layout and wiring data is described in Japanese Patent Application Laid-open No. 2007-12687 (hereinafter, referred to as Patent Document 1). Patent Document 1 describes a design assistance system for a semiconductor integrated circuit, which includes: layout means for determining a layout of a chip by defining a plurality of regions in the chip and layouting and connecting cells, wires, and via holes automatically in each region; production easiness analyzing means for analyzing production easiness of the layout based on an occurrence frequency of defect patterns calculated for each region by reading out defect pattern information and verifying the same with a result of the layout determination; and layout correcting means for correcting the layout of the cells, the wires, and the via holes in the region after selectively extracting the region having the occurrence frequency that is a predetermined value or higher.

In the design assistance system described in Patent Document 1, the result of the determination of the read layout is verified with information of defect patterns when the occurrence frequency of the defect patterns is computed. For performing the verification, it is necessary to prepare the defect pattern information in advance that indicates which layout result becomes a defect pattern. However, it is difficult to cover completely the layout results to be the defect patterns. Therefore, it is considered that the result of the layout determination may include a defect pattern that is not prepared. In this case, the defect part is overlooked. In other words, it is difficult to perform accurate verification by the technology of Patent Document 1.

In order to perform accurate verification, it is considered to simulate a shape of the pattern that is actually formed and to detect the defect part based on a result of the simulation. FIG. 1 is a conceptional diagram illustrating an example of a method of detecting the defect part based on a result of the simulation.

As illustrated in FIG. 1, in the first place, a place and route (P&R) tool is used for performing automatic layout and wiring, and hence layout and wiring data 101 is obtained. The layout and wiring data 101 indicates a position of a primitive cell 102 and a position of a connection wire 104 to be connected to the primitive cell. The primitive cell 102 includes a terminal 103.

Next, mask data is created based on the layout and wiring data 101, and the mask data is supplied to a verification tool. Here, the mask data is data indicating patterns drawn on the mask. The information indicating a position of the primitive cell is not necessary for the mask data and therefore is eliminated. The verification tool performs an optical proximity correction (OPC) process based on the mask data. As a result of the OPC process, the mask data is delivered as post-OPC data 105. In the post-OPC data 105, a region corresponding to the connection wire 104 and a region corresponding to the terminal 103 are both expressed as a wiring pattern 106.

After that, a shape of the pattern that is actually formed on the substrate is simulated based on the post-OPC data 105 so that post-simulation data 107 is obtained. Based on the post-simulation data 107, verification of an error part is performed. In the example illustrated in FIG. 1, there is a narrow space between the wiring pattern 106 and the neighboring pattern in a part of the regions. Such the region is detected as an error part 109. Based on the error part 109, a correction hint 108 is created so that the position of the wiring pattern 106 is changed. In this case, the correction hint 108 is created independently of the position of the primitive cell 102. The correction hint 108 is sent as a notice from the verification tool to the P&R tool.

The P&R tool corrects the layout and wiring data 101 based on the correction hint 108. In this case, if the position of the terminal 103 in the primitive cell 102 is changed, the signal communication timing may be shifted so that the final timing verification may not be performed. Therefore, the position of the terminal 103 may not be changed during the correction. However, as described above, the correction hint 108 is created independently of the position of the primitive cell 102. Therefore, the correction hint 108 for moving the position of the terminal 103 may be created. Such the case may not be supported only by correction of the wiring, and therefore the layout of the primitive cell 102 should be performed again. Otherwise, the pattern itself in the primitive cell 102 should be created again. Redoing the layout or the creation of the primitive cell 102 causes an increase of turn around time (TAT).

In other words, there is a problem that if the method of detecting the defect part based on the mask data is used, it becomes difficult to correct the layout and wiring data without changing the position of the terminal included in the primitive cell.

### SUMMARY

A layout verification apparatus according to the present invention includes: verification means for obtaining mask data indicating a mask pattern to be drawn on a mask based on layout and wiring data indicating positions of a group of primitive cells and positions of connection wires connected to the group of primitive cells, and for verifying a position of the mask pattern based on the mask data, so as to detect an error part; and correction hint creating means for creating correction hint information based on the error part, and for sending the correction hint information to layout and wiring means for correcting the layout and wiring data. The correction hint creating means creates the correction hint information based on terminal information indicating positions of a group of terminals included in the group of primitive cells so that the positions of the group of terminals are not changed by the layout and wiring means.

According to the present invention, the correction hint creating means creates the correction hint information based on the terminal information. Therefore, it is possible to recognize the position at which the terminal exists when the correction hint is created. Thus, it is possible to create the correction hint such that the position of the terminal is not changed. As a result, the layout and wiring data may be corrected without changing the position of the terminal. Thus, the layout and wiring data may be corrected without redoing the layout of the primitive cell.

A layout apparatus according to the present invention includes: the above-mentioned layout verification apparatus; and layout and wiring means for correcting positions of the connection wires in the layout and wiring data based on the correction hint information, so as to output the corrected data as wiring layout data.

A layout verification method according to the present invention includes: obtaining, by a computer, mask data indicating positions of mask regions that are masked when wirings are formed based on layout and wiring data indicating positions of a group of primitive cells and positions of connection wires connected to the group of primitive cells, and verifying the positions of the mask regions based on the mask data, so as to detect an error part; creating, by the computer, correction hint information based on the error part; and sending, by the computer, the correction hint information to layout and wiring means for correcting the layout and wiring data. The creating the correction hint information includes creating the correction hint information based on terminal information indicating positions of a group of terminals included in the group of primitive cells so that the positions of the group of terminals are not changed by the layout and wiring means.

A layout verification program according to the present invention is a program for realizing, by using a computer, the above-mentioned layout verification method.

A wiring forming method according to the present invention includes: correcting positions of the connection wires in the layout and wiring data based on the correction hint information that is sent by the above-mentioned layout verification method, so as to create wiring layout data; manufacturing a mask based on the wiring layout data; and forming wirings by using the mask.

According to the present invention, it is possible to provide a layout verification apparatus, a layout apparatus, a layout verification program, and a wiring forming method, each of which enables correction of the layout and wiring data without changing the position of the terminal even if the method of detecting the defect part based on a result of the simulation is used.

### BRIEF DESCRIPTION OF THE DRAWINGS

In the accompanying drawings:

FIG. 1 is a conceptional diagram illustrating a correction method;

FIG. 2 is a functional block diagram illustrating a layout apparatus;

FIG. 3 is a flowchart illustrating a layout verification method;

FIG. 4 is a conceptional diagram illustrating a method of creating a correction hint;

FIG. 5 is a conceptional diagram illustrating the method of creating the correction hint;

FIG. 6 is a conceptional diagram illustrating the method of creating the correction hint;

FIG. 7A is a conceptional diagram illustrating the method of creating the correction hint;

FIG. 7B is a conceptional diagram illustrating the method of creating the correction hint;

FIG. 8 is a conceptional diagram illustrating the method of creating the correction hint;

FIG. 9A is a conceptional diagram illustrating the method of creating the correction hint;

FIG. 9B is a conceptional diagram illustrating the method of creating the correction hint; and

FIG. 9C is a conceptional diagram illustrating the method of creating the correction hint.

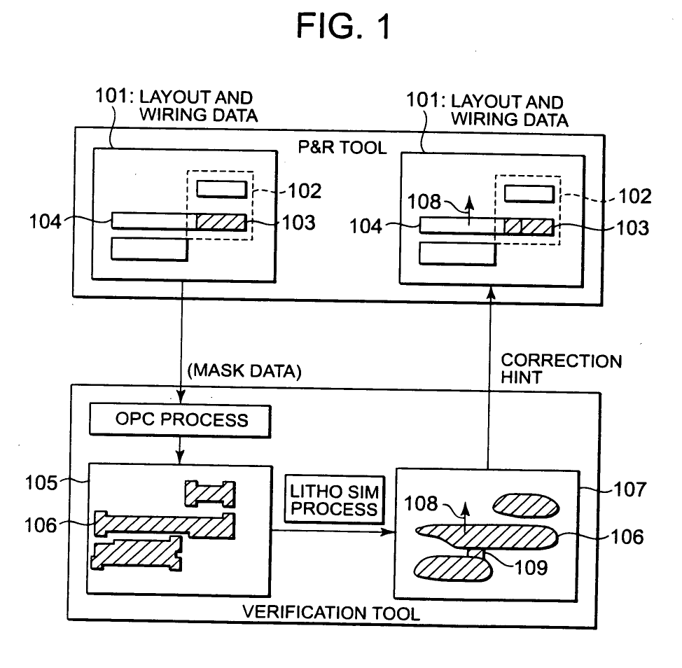

### DETAILED DESCRIPTION OF THE PREFERRED EMBODIMENT

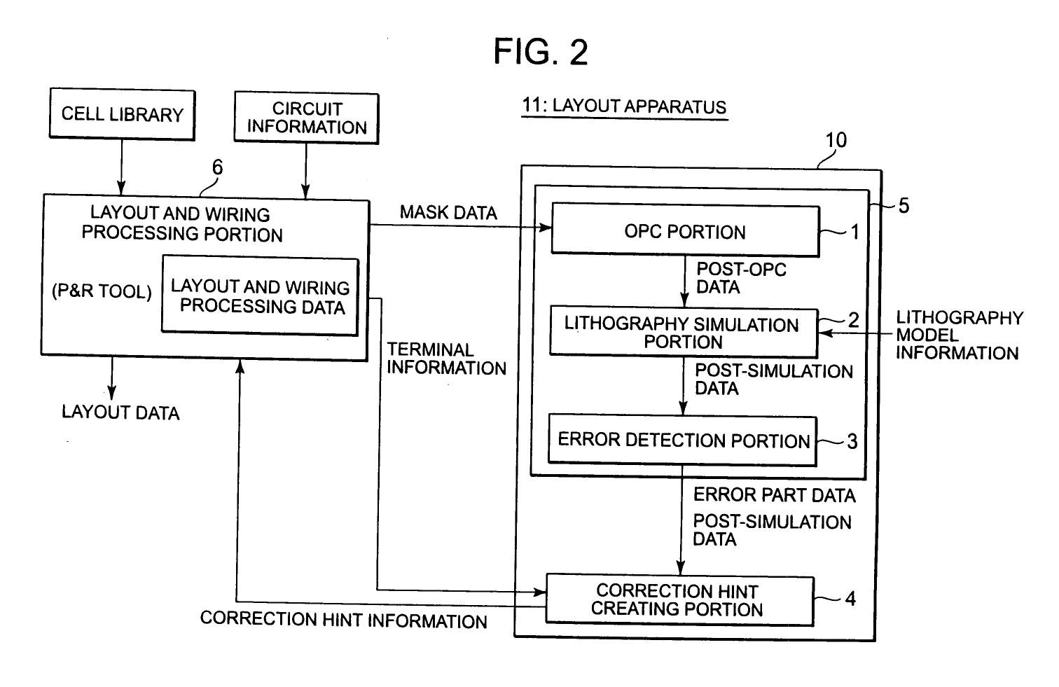

Now, an embodiment of the present invention is described with reference to the attached drawings. FIG. 2 is a schematic block diagram illustrating a layout apparatus 11 according to this embodiment.

As illustrated in FIG. 2, the layout apparatus 11 includes a layout and wiring processing portion 6 for performing a layout and wiring process, and a layout verification apparatus 10 for performing verification of the layout. The layout verification apparatus 10 includes a verification portion 5 and a correction hint creating portion 4. The verification portion 5 includes an optical proximity correction (OPC) portion 1, a lithography simulation portion 2, and an error detection portion 3.

The layout and wiring processing portion 6 and the layout verification apparatus 10 are realized by central processing means (CPU) executing a layout program installed in a computer. In particular, the layout verification apparatus 10 is realized by a layout verification program contained in the layout program. In addition, the layout program is copied from a storage medium such as a digital versatile disk (DVD) and is stored in a read only memory (ROM) of the computer.

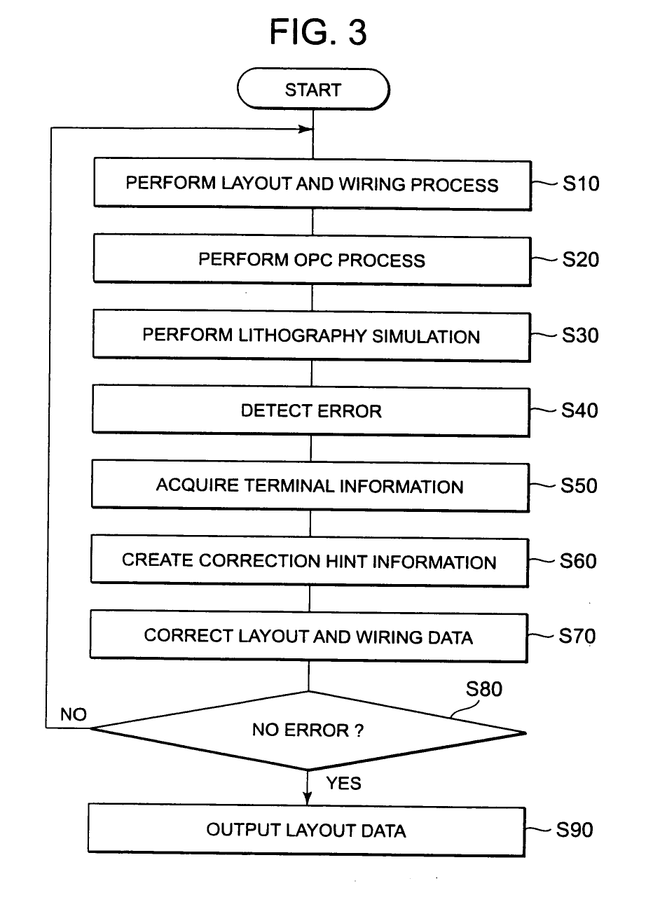

FIG. 3 is a flowchart illustrating a layout verification method according to this embodiment.

Step S10; Perform Layout and Wiring Process

The layout and wiring processing portion 6 performs the layout of a group of primitive cells and the wiring among the primitive cells, and creates the layout and wiring data. Specifically, the layout and wiring processing portion 6 obtains circuit information and refers to a cell library so as to perform the layout and the wiring. The circuit information indicates a group of functional circuits (logic circuits or the like) to be used and a connection relationship among the functional circuits, and the circuit information is prepared in advance. The cell library is a database indicating a pattern forming each of the functional circuits as the primitive cell. The primitive cell is set for each functional circuit. The cell library is also prepared in advance similarly to the circuit information.

The layout and wiring data created by the layout and wiring processing portion 6 is converted into mask data and is sent to the layout verification apparatus 10. The mask data is information indicating a mask pattern to be drawn on a photomask. The mask data is information indicating a region to be shielded from light when exposure is performed and a region through which light may pass when the exposure is performed. In the mask data, the information indicating the position of the primitive cell is lost, and the mask pattern is expressed as graphic data. As the mask data, there is GDS2 data for example.

Step S20; Perform OPC Process

In the layout verification apparatus 10, the OPC portion 1 performs OPC with respect to the mask data, and creates post-OPC data. The post-OPC data is also graphic data similarly to the mask data. The post-OPC data is sent to the lithography simulation portion 2.

Step S30; Perform Lithography Simulation

The lithography simulation portion 2 obtains the post-OPC data and refers to lithography model information so as to perform lithography simulation. The lithography simulation portion 2 determines a shape of the pattern that is actually formed. The determined shape is sent as post-simulation data to the error detection portion 3. The post-simulation data is also graphic data similarly to the mask data. Note that the lithography model information includes information indicating a parameter that affects a shape of the pattern that is actually formed. For instance, the lithography model information includes information indicating step conditions or the like in the lithography step.

Step S40; Detect Error

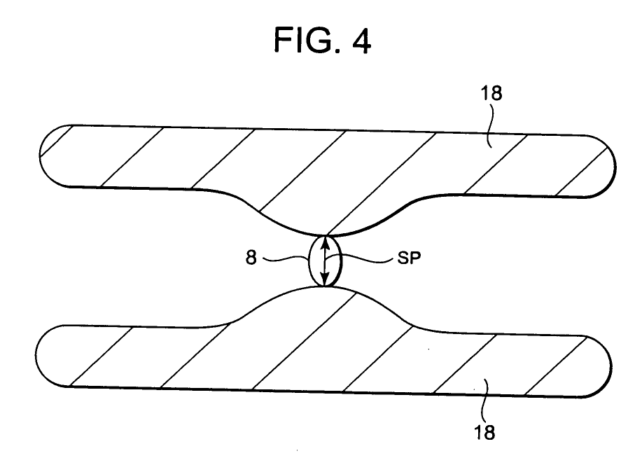

The error detection portion 3 detects an error part based on the post-simulation data. FIG. 4 is a conceptional diagram illustrating an example of an operation of the error detection portion 3. FIG. 4 illustrates patterns 18 indicated in the post-simulation data. The error detection portion 3 computes a space SP formed between the patterns 18. If the space SP is smaller than a threshold value that is set in advance, the part is detected as an error part 8. The error detection portion 3 sends the detected error part 8 associated with its position to the correction hint creating portion 4. In addition, the post-simulation data is also sent from the error detection portion 3 to the correction hint creating portion 4.

Step S50; Acquire Terminal Information

Then, the correction hint creating portion 4 obtains terminal information from the layout and wiring processing portion 6. The terminal information indicates a position of a terminal included within the primitive cell.

Step S60; Create Correction Hint Information

Next, the correction hint creating portion 4 creates the correction hint information indicating the correction hint, based on the error part 8. In this case, the correction hint creating portion 4 recognizes a part of the post-lithography-simulation data corresponding to the terminal as a terminal pattern based on the terminal information. In addition, the correction hint creating portion 4 recognizes parts other than the part corresponding to the terminal as a wiring pattern. Then, the correction hint creating portion 4 creates the correction hint information so that the position of the terminal pattern is not changed. The created correction hint information is sent to the layout and wiring processing portion 6.

Step S70; Correct Layout and Wiring Data

Next, the layout and wiring processing portion 6 performs correction of the layout and wiring data based on the obtained correction hint information. Here, the position of the terminal is not changed, and hence the layout and wiring processing portion 6 changes only the position of the wiring that connects the primitive cells. Therefore, the layout and wiring data may be corrected without redoing the layout of the primitive cell.

Steps S80 and S90; Is There Any Error?

Next, based on the corrected layout and wiring data, the process from Step S20 to Step S40 is performed again, and the error detection portion 3 performs the detection of the error part again. If no error part is detected, the process of the final timing verification and the like is performed with respect to the layout and wiring data, and then layout data is output (Step S90). The output layout data is used for producing a photomask. The mask pattern drawn on the produced photomask is transferred onto the substrate when the actual circuit is manufactured. Thus, the actual circuit is manufactured. On the other hand, if an error part is detected in Step S80, the process of Step S10 and the subsequent steps is performed.

As described above, according to this embodiment, the correction hint creating portion 4 obtains the terminal information so as to recognize which part in the graphic data (post-simulation data) is the pattern corresponding to the terminal. Thus, the correction hint creating portion 4 may create the correction hint information so that the position of the terminal part is not changed. As a result, when the layout and wiring data is corrected, it is not necessary to redo the layout of the primitive cell. Thus, the layout and wiring data may be corrected without increasing the TAT.

Next, an operation of the correction hint creating portion 4 creating the correction hint information is described in detail.

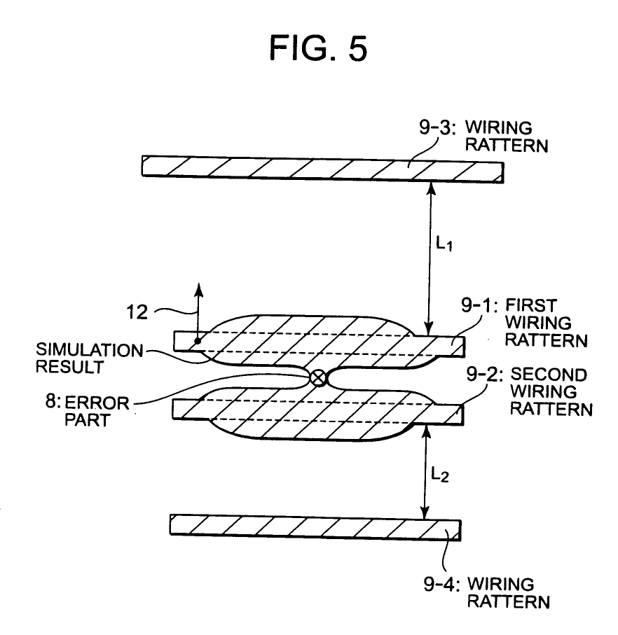

First, an operation performed when the error part 8 is detected between the wiring patterns is described. FIG. 5 is a conceptional diagram illustrating an example of the post-simulation data. In FIG. 5, the full line indicates a pattern shape after the simulation, and the broken line indicates a pattern shape before the simulation. As illustrated in FIG. 5, it is supposed that the space between a first wiring pattern 9-1 and a second wiring pattern 9-2 is narrow in the post-simulation data and that the error part 8 is detected between the first wiring pattern 9-1 and the second wiring pattern 9-2.

In this case, the correction hint creating portion 4 recognizes a wiring pattern 9-3 that is adjacent to the first wiring pattern 9-1 except for the second wiring pattern 9-2. The correction hint creating portion 4 determines a length of a space L1 formed between the wiring pattern 9-3 and the first wiring pattern 9-1. In addition, the correction hint creating portion 4 recognizes a wiring pattern 9-4 that is adjacent to the second wiring pattern 9-2 except for the first wiring pattern 9-1. The correction hint creating portion 4 determines a length of a space L2 formed between the wiring pattern 9-4 and the first wiring pattern 9-2. Then, the correction hint creating portion 4 compares the length of the space L1 with the length of the space L2. If the length of the space L1 is larger than the length of the space L2, the correction hint creating portion 4 creates a correction hint 12 so that a position of the first wiring pattern 9-1 is changed. On the other hand, if the length of the space L2 is larger than the length of the space L1, the correction hint creating portion 4 creates the correction hint 12 so that a position of the second wiring pattern 9-2 is changed. In the example illustrated in FIG. 5, the length of the space L1 is larger than the length of the space L2. Therefore, the correction hint 12 is created so that the first wiring pattern 9-1 is moved toward the wiring pattern 9-3.

As the length of the space between neighboring wiring patterns is smaller, a short circuit may occur more easily. Therefore, if the position of the second wiring pattern 9-2 is changed in the example illustrated in FIG. 5, the error part 8 is cancelled, but a new error (short circuit) may occur between the second wiring pattern 9-2 and the wiring pattern 9-4. In contrast, if the wiring pattern having a larger space with the neighboring wiring pattern (first wiring pattern 9-1 in FIG. 5) is moved, the probability of occurrence of a new error may be lowered, and hence the layout and wiring data may be corrected more securely.

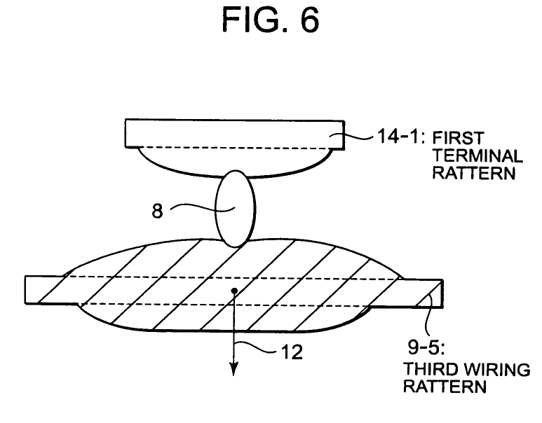

Next, an operation performed when the error part 8 is detected between the terminal pattern and the wiring pattern is described. FIG. 6 is a conceptional diagram illustrating an example of the post-simulation data. As illustrated in FIG. 6, it is supposed that the space between a first terminal pattern 14-1 and a third wiring pattern 9-5 is narrow and that the error part 8 is detected between the first terminal pattern 14-1 and the third wiring pattern 9-5.

In the case of the example illustrated in FIG. 6, the correction hint creating portion 4 creates the correction hint 12 so that the position of the third wiring pattern 9-5 is changed. Thus, when the correction is performed, the position of the part corresponding to the third wiring pattern 9-5 is changed while the part corresponding to the first terminal pattern 14-1 is not changed in the layout and wiring data.

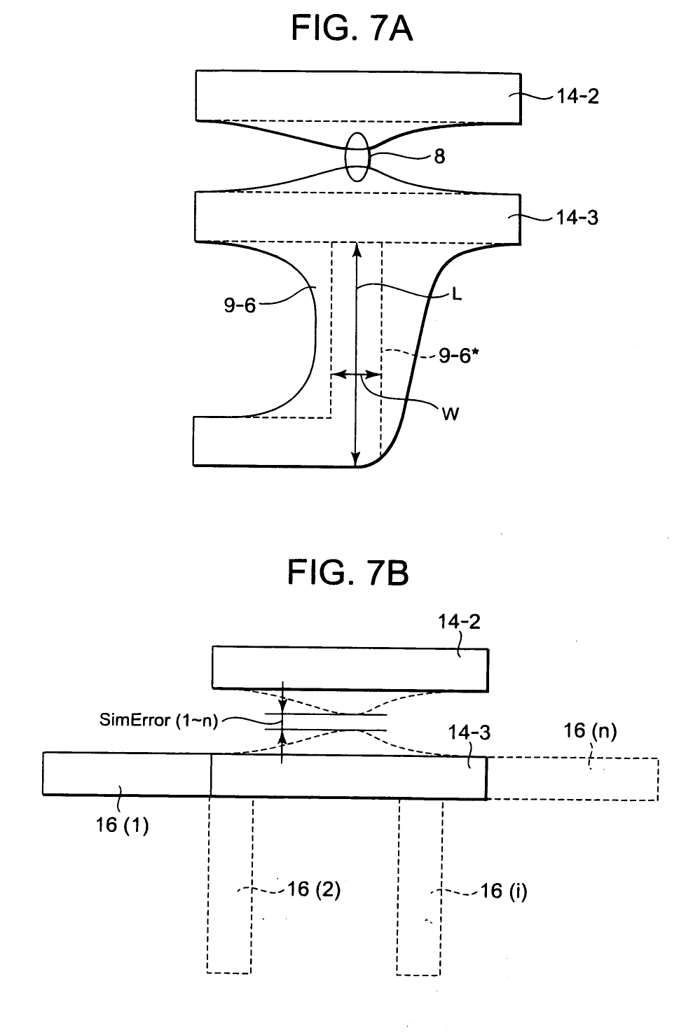

Next, an operation performed when the error part 8 is detected between the terminal patterns is described. FIG. 7A is a conceptional diagram illustrating an example of the post-simulation data.

It is supposed that the error part 8 is detected between a third terminal pattern 14-2 and a fourth terminal pattern 14-3 as illustrated in FIG. 7A. In this case, the correction hint creating portion 4 recognizes a wiring pattern that is connected to the third terminal pattern 14-2 or the fourth terminal pattern 14-3 as a fourth wiring pattern 9-6. In the example illustrated in FIG. 7A, the wiring pattern that is connected to the fourth terminal pattern 14-3 is recognized as the fourth wiring pattern 9-6. Then, the correction hint creating portion 4 creates the correction hint information so that the position of a part corresponding to the fourth wiring pattern 9-6 is changed in the layout and wiring data.

Specifically, the correction hint creating portion 4 refers to data before the simulation (mask data or post-OPC data) so as to recognize a pattern 9-6* corresponding to the fourth wiring pattern 9-6. Then, the correction hint creating portion 4 changes the position of the pattern 9-6* in the mask data to be correction candidates 16(1) to 16(n) as illustrated in FIG. 7B. The correction hint creating portion 4 performs the lithography simulation with the lithography simulation portion 2 on each of the mask data (or post-OPC data) that is changed to be the correction candidates 16(1) to 16(n), so as to determine a space SimError (1) to (n) formed between the third terminal pattern 14-2 and the fourth terminal pattern 14-3. The correction hint creating portion 4 creates the correction hint 12 so that the wiring corresponding to the pattern 9-6 is changed to be the correction candidate 16 when SimError becomes minimum in the layout and wiring data, and sends the same to the layout and wiring processing portion 6.

Note that the lengths and line widths of the correction candidates 16(1) to 16(n) are determined based on the pattern 9-6*. Specifically, the pattern 9-6* extends linearly from the terminal part and is bent at a midpoint. Therefore, the correction hint creating portion 4 determines the length from the terminal part to the bent part of the pattern 9-6* as a length L. In addition, the correction hint creating portion 4 determines the line width of the pattern 9-6 as a line width W. Then, the correction hint creating portion 4 sets the correction candidate 16 so that the line width and the length become W and L, respectively.

As illustrated in FIG. 7A, if the error part 8 is detected between the terminal pattern 14 and the terminal pattern 14, it seems difficult to cancel the error because the terminal pattern 14 may not be moved. However, a shape of the terminal that is actually formed may be changed by changing the position of the wiring connected to the terminal. Therefore, if the position of the wiring part connected to the terminal is changed in the layout and wiring data, the layout and wiring data may be corrected more securely.

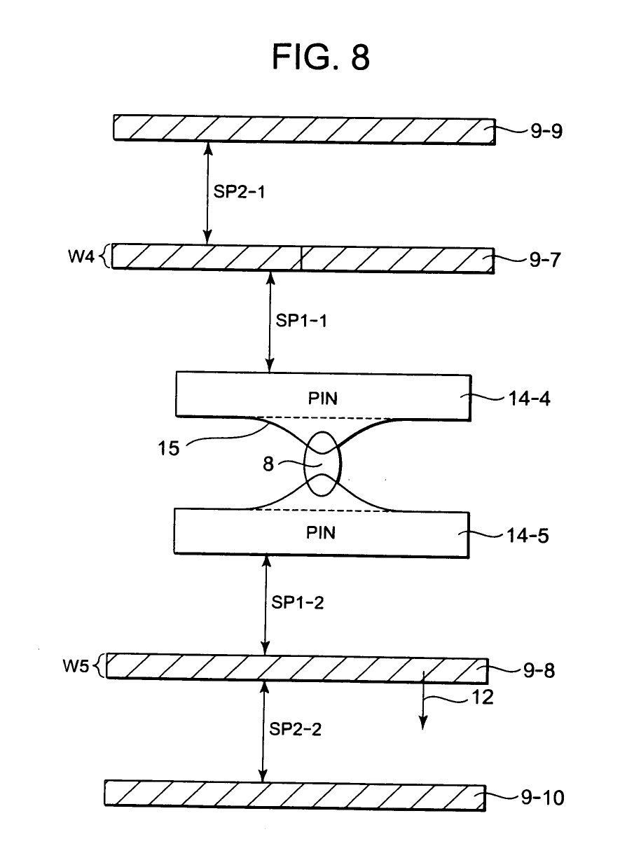

Next, another operation performed when the error part 8 is detected between the terminal patterns is described. FIG. 8 is a conceptional diagram illustrating an example of the post-simulation data.

It is supposed that the error part 8 is detected between a fourth terminal pattern 14-4 and a fifth terminal pattern 14-5 as illustrated in FIG. 8. In addition, it is supposed that the wiring pattern 9 is not connected to the fourth terminal pattern 14-4 and the fifth terminal pattern 14-5. In this case, the correction hint creating portion 4 recognizes the wiring pattern 9 that is adjacent to the fourth terminal pattern 14-4 as a fourth neighboring pattern 9-7. In addition, the correction hint creating portion 4 recognizes the wiring pattern 9 that is adjacent to the fifth terminal pattern 14-5 as a fifth neighboring pattern 9-8. Further, the correction hint creating portion 4 determines any one of the fourth neighboring pattern 9-7 and the fifth neighboring pattern 9-8 as an alteration wiring pattern. The correction hint creating portion 4 creates the correction hint information so that the position of the part corresponding to the alteration wiring pattern is changed in the layout and wiring data.

Specifically, the correction hint creating portion 4 determines a line width W4 of the fourth neighboring pattern 9-7 and a line width W5 of the fifth neighboring pattern 9-8. In addition, the correction hint creating portion 4 determines a space SP1-1 formed between the fourth neighboring pattern 9-7 and the fourth terminal pattern 14-4, and a space SP1-2 formed between the fifth neighboring pattern 9-8 and the fifth terminal pattern 14-5. In addition, the correction hint creating portion 4 recognizes the wiring pattern 9, which is adjacent to the fourth neighboring pattern 9-7 and is not the fourth terminal pattern 14-4, as a fourth pattern 9-9. Similarly, the correction hint creating portion 4 recognizes the wiring pattern 9, which is adjacent to the fifth neighboring pattern 9-8 and is not the fifth terminal pattern 14-5, as a fifth pattern 9-10. Then, the correction hint creating portion 4 determines a space SP2-1 formed between the fourth neighboring pattern 9-7 and the fourth pattern 9-9, and a space SP2-2 formed between the fifth neighboring pattern 9-8 and the fifth pattern 9-10.

Each of the determined values W4, W5, SP1-1, SP1-2, SP2-1, and SP2-2 is a parameter that affects the shape of the terminal pattern 14 in the post-simulation data. Therefore, the correction hint creating portion 4 decides which one of the fourth neighboring pattern 9-7 and the fifth neighboring pattern 9-8 should be set as the alteration wiring pattern based on these parameters. Specifically, the correction hint creating portion 4 computes an evaluation score X-4 for the fourth neighboring pattern 9-7 and an evaluation score X-5 for the fifth neighboring pattern 9-8 in accordance with the following equations (1) and (2).

X-4=(αW4+γSP2-1)/βSP1-1 Equation (1);

X-5=(αW5+γSP2-2)/βSP1-2 Equation (2);

In Equations (1) and (2), α denotes a parameter indicating a weight of the line width W, β denotes a parameter indicating a weight of SP1-1 or SP1-2, and γ denotes a parameter indicating a weight of SP2-1 or SP2-2. The parameters are set in advance in a random access memory (RAM) or the like. It is preferable that the weights have a relationship of “γ>β>α”.

The correction hint creating portion 4 compares the evaluation score X-4 with the evaluation score X-5, and creates the correction hint information so that the position of the part corresponding to the wiring pattern 9 having a larger value is changed in the layout and wiring data.

As illustrated in FIG. 8, if the error part 8 is detected between a terminal pattern and another terminal pattern, and the terminal pattern and the another terminal pattern are not connected to the wiring pattern, it is considered to be difficult to cancel the error part 8. However, as described above, the shape of the terminal pattern 14 in the post-simulation data may be changed by taking into account the line widths W (W4 and W5), the spaces SP1 (SP1-1 and SP1-2), and the spaces SP2 (SP2-1 and SP2-2), and hence the layout and wiring data may be corrected more securely. In this case, if the widths W (W4 and W5) are large while the neighboring spaces SP1 (SP1-1 and SP1-2) are small, the corresponding wiring pattern 9 is moved with high priority because that wiring pattern 9 may cause a short circuit or the like with high probability. In addition, if the spaces SP2 (SP2-1 and SP2-2) are large, the corresponding wiring pattern 9 is moved with high priority because that wiring pattern 9 may be easily moved.

Note that, in the example described above, the correction hint creating portion 4 creates the correction hint information by taking into account all the line widths W (W4 and W5), the spaces SP1 (SP1-1 and SP1-2), and the spaces SP2 (SP2-1 and SP2-2). However, it is possible to create the correction hint information by taking into account only the line widths W (W4 and W5). Similarly, it is also possible to create the correction hint information by taking into account only the spaces SP1 (SP1-1 and SP1-2) or to create the correction hint information by taking into account only the spaces SP2 (SP2-1 and SP2-2).

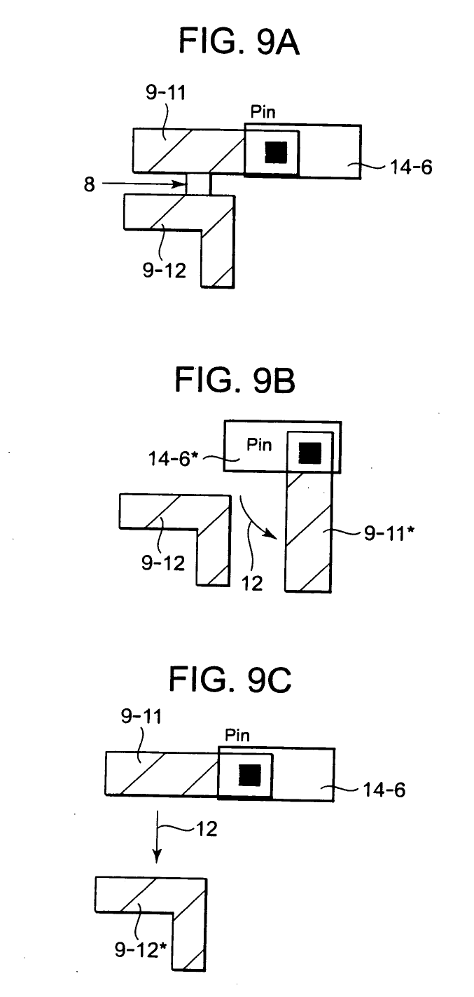

Then, an operation is described with regard to the case where the error part 8 is detected between one wiring pattern and another wiring pattern, and the one wiring pattern is connected to the terminal pattern. FIG. 9A is a conceptional diagram illustrating an example of the post-simulation data.

As illustrated in FIG. 9A, it is supposed that the error part 8 is detected between a wiring pattern 9-11 and a wiring pattern 9-12. In addition, it is supposed that the wiring pattern 9-11 is connected to a terminal pattern 14-6.

In this case, the correction hint creating portion 4 creates the correction hint 12 so that the connection between a part corresponding to the wiring pattern 9-11 and a part corresponding to the terminal pattern 14-6 is maintained in the layout and wiring data. Specifically, as illustrated in FIG. 9B, the correction hint creating portion 4 creates the correction hint 12 so that a connection part and a correction direction between a part 9-11* corresponding to the wiring pattern 9-11 and a part 14-6* corresponding to the terminal pattern 14-6 are changed in the layout and wiring data. Alternatively, the correction hint creating portion 4 creates the correction hint 12 so that the position of a part 9-12* corresponding to the wiring pattern 9-12 is changed as illustrated in FIG. 9C.

In the case of the example illustrated in FIG. 9A, if the part 9-11* corresponding to the wiring pattern 9-11 is moved in the layout and wiring data, the connection with the part 14-6* corresponding to the terminal pattern 14-6 may be cut off depending on the moving direction. On the contrary, if the correction hint 12 is created so that the connection is maintained as described above, it is possible to prevent the connection from being cut off.

As described above, according to this embodiment, the correction hint creating portion 4 obtains the terminal information and creates the correction hint based on the terminal information so that the position of the terminal is not changed. Therefore, despite that the verification is performed based on the mask data that does not contain the information indicating the position of the primitive cell, the layout and wiring data may be corrected without changing the position of the primitive cell. As a result, it is not necessary to create the pattern included in the primitive cell again or to redo the layout of the primitive cell, and hence TAT may be reduced.

What is claimed is:

1. A layout verification apparatus, comprising:
verification means for obtaining mask data indicating a mask pattern to be drawn on a mask based on layout and wiring data indicating positions of a group of primitive cells and positions of connection wires connected to the group of primitive cells, and for verifying a position of the mask pattern based on the mask data, so as to detect an error part; and
correction hint creating means for creating correction hint information based on the error part, and for sending the correction hint information to layout and wiring means for correcting the layout and wiring data,
wherein the correction hint creating means obtains terminal information indicating positions of a group of terminals included in the group of primitive cells and creates the correction hint information based on the terminal information so that the positions of the group of terminals are not changed by the layout and wiring means.

2. A layout verification apparatus according to claim 1, wherein the verification means includes:
lithography simulation means for simulating a wiring shape that is formed after a lithography step is performed based on the mask data, so as to create post-lithography graphic data; and
error detection means for detecting the error part based on the post-lithography graphic data.

3. A layout verification apparatus according to claim 2, wherein:
the verification means further includes optical proximity correction (OPC) means for performing an OPC process on the mask data so as to create post-OPC graphic data; and
the lithography simulation means creates the post-lithography graphic data based on the post-OPC graphic data.

4. A layout verification apparatus according to claim 2, wherein the correction hint creating means recognizes a group of patterns corresponding to the connection wires and a group of patterns corresponding to the group of terminals as a group of wiring patterns and a group of terminal patterns, respectively, in the post-simulation data based on the terminal information.

5. A layout verification apparatus according to claim 4, wherein if the error part is detected between a first wiring pattern and a second wiring pattern, and if a space L1 formed between the first wiring pattern and a wiring pattern, which is adjacent to the first wiring pattern and is not the second wiring pattern, is larger than a space L2 formed between the second wiring pattern and a wiring pattern, which is adjacent to the second wiring pattern and is not the first wiring pattern, the correction hint creating means creates the correction hint information so that a position of a part corresponding to the first wiring pattern is changed in the layout and wiring data.

6. A layout verification apparatus according to claim 4, wherein if the error part is detected between a first terminal pattern and a third wiring pattern, the correction hint creating means creates the correction hint information so that a position of a part corresponding to the third wiring pattern is changed in the layout and wiring data.

7. A layout verification apparatus according to claim 1, wherein if the error part is detected between a third terminal pattern and a fourth terminal pattern, the correction hint creating means recognizes a wiring pattern that is connected to one of the third terminal pattern and the fourth terminal pattern as the fourth wiring pattern, and creates the correction hint information so that a position of a part corresponding to the fourth wiring pattern is changed in the layout and wiring data.

8. A layout verification apparatus according to claim 21, wherein if the error part is detected between a fourth terminal pattern and a fifth terminal pattern, the correction hint creating means recognizes a wiring pattern that is adjacent to the fourth terminal pattern as a fourth neighboring pattern, recognizes a wiring pattern that is adjacent to the fifth terminal pattern as a fifth neighboring pattern, determines any one of the fourth neighboring pattern and the fifth neighboring pattern as an alteration wiring pattern, and creates the correction hint information so that a position of a part corresponding to the alteration wiring pattern is changed in the layout and wiring data.

9. A layout verification apparatus according to claim 8, wherein the correction hint creating means determines the alteration wiring pattern based on a line width W4 of the fourth neighboring pattern and a line width W5 of the fifth neighboring pattern.

10. A layout verification apparatus according to claim 8, wherein the correction hint creating means determines the alteration wiring pattern based on a space SP1-1 formed between the fourth neighboring pattern and the fourth terminal pattern and a space SP1-2 formed between the fifth neighboring pattern and the fifth terminal pattern.

11. A layout verification apparatus according to claim 8, wherein the correction hint creating means recognizes a wiring pattern, which is adjacent to the fourth neighboring pattern and is not the fourth terminal pattern, as a fourth pattern, recognizes a wiring pattern, which is adjacent to the fifth neighboring pattern and is not the fifth terminal pattern, as a fifth pattern, and determines the alteration wiring pattern based on a space SP2-1 formed between the fourth neighboring pattern and the fourth pattern and a space SP2-2 formed between the fifth neighboring pattern and the fifth pattern.

12. A layout apparatus, comprising:
the layout verification apparatus according to claim 1; and
layout and wiring means for correcting positions of the connection wires in the layout and wiring data based on the correction hint information, so as to output the corrected data as wiring layout data.

13. A layout verification method, comprising:
obtaining, by a computer, mask data indicating positions of mask regions that are masked when wirings are formed based on layout and wiring data indicating positions of a group of primitive cells and positions of connection wires connected to the group of primitive cells, and verifying the positions of the mask regions based on the mask data, so as to detect an error part;
creating, by the computer, correction hint information based on the error part; and
sending, by the computer, the correction hint information to layout and wiring means for correcting the layout and wiring data,
wherein the creating the correction hint information includes creating the correction hint information based on terminal information indicating positions of a group of terminals included in the group of primitive cells so that the positions of the group of terminals are not changed by the layout and wiring means.

14. A layout verification program for realizing, by using a computer, the layout verification method according to claim 13.

15. A wiring forming method, comprising:
correcting, by using a computer, position of connection wires in layout and wiring data based on correction hint information that is sent by the layout verification method according to claim 13, so as to create wiring layout data;
manufacturing a mask based on the wiring layout data; and
forming wirings by using the mask.
